(19) United States
(12) Patent Application Publication
(10) Pub. No.: US 2010/0054843 A1
(43) Pub. Date: Mar. 4, 2010

(54) Powered Cosmetic Device

(76) Inventor: Lori M. Howard, New Hope, MN (US)

Correspondence Address: Jeffrey C. Brown & Associates PLLC, 100 South Fifth Street, Suite 1900, Minneapolis, MN, 55402, US

(21) Appl. No.: 12/199,792

(22) Filed: Aug. 27, 2008

(51) Int. Cl. A47K 7/02; B43K 23/08

(52) U.S. Cl. 401/143; 401/262

(57) ABSTRACT

A cosmetic device for applying skin-care substances to hard-to-reach areas of a human body, like the human back, is disclosed. The device includes a variable length shaft, a motorized applicator head adapted for user-selectable rotation, oscillation, and/or vibration, and a plurality of head covers comprising synthetic and/or natural materials.

### BACKGROUND OF THE INVENTION

1. Field of the Invention

The present invention relates to a powered hand-held device, more specifically, a cosmetic device for applying skin-care substances like lotions, ointments, creams, etc. to hard-to-reach areas of a human body, like the human back.

2. Description of the Prior Art

It is generally very difficult for a person to apply substances like lotions, ointments, oils, sunscreen, creams, soap, etc. to his or her own back effectively or thoroughly, or reach certain areas of the back. Consequently, many devices exist to assist a person in scratching, scrubbing, moisturizing, or massaging the back without the assistance of another person. The art is replete with designs and devices for applying fluids, lotions, and the like to the human back. Many such designs and devices include an elongated handle to reach inaccessible areas of the back and an applicator head for applying the substance or massage. Such devices lack, however, means to rotate, oscillate, or vibrate the applicator head to simulate the rubbing and/or massaging action of a human hand. They also lack other useful features, like being rechargeable and having interchangeable applicator head covers for multiple cosmetic uses.

Thus, there is a need for a cosmetic device that can mimic the rubbing and/or massaging action of a human hand, is rechargeable, and has interchangeable head covers for different types of applied substances and uses.

### BRIEF SUMMARY OF THE INVENTION

The present invention provides a cosmetic device comprising a variable length shaft further comprising a soft-grip handle and a housing adapted to include a motorized applicator head or base. The applicator is operably connected to an electrically powered motor. The electrical power source to the motor may include a direct electrical connection to an outside power source, like a conventional electrical outlet, and/or at least one rechargeable or disposable battery. The user may select or program the head to rotate, oscillate, vibrate, or combinations thereof. The applicator base is further adapted to accommodate a plurality of head covers, including covers made of synthetic and natural materials.

### DESCRIPTION OF THE DRAWINGS

The invention can be better understood by reference to the following drawings, wherein:

FIG. 1 is an embodiment of the cosmetic device.

FIG. 2 is a further embodiment of the cosmetic device.

FIG. 3 is a perspective view of the cosmetic device.

### DETAILED DESCRIPTION

In the following detailed description, reference is made to the accompanying drawings that form a part hereof, and in which are shown by way of illustration specific embodiments or examples. These embodiments may be combined, other embodiments may be utilized, and structural, logical, and procedural changes may be made without departing from the spirit and scope of the present invention. The following detailed description is, therefore, not to be taken in a limiting sense, and the scope of the present invention is defined by the appended claims and their equivalents.

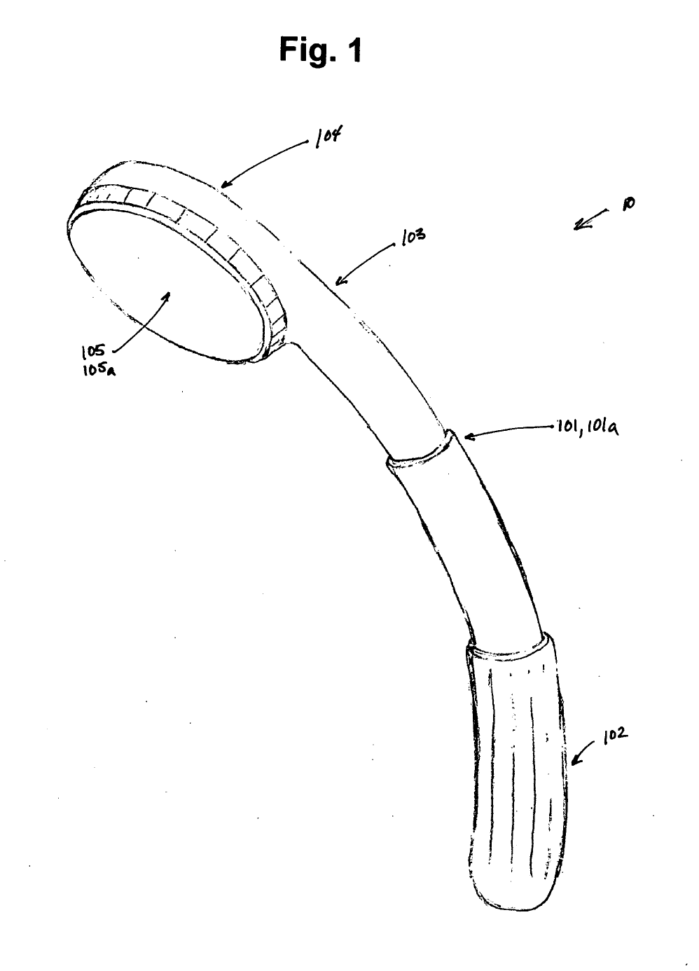

In an embodiment of the cosmetic device 10 shown in FIG. 1, the variable length shaft 101 includes telescopic means 101a to allow the shaft to be elongated for use and retracted for storage or portability. The shaft further includes a soft-grip handle end 102 and a terminal end 103 proximate the housing 104. The soft-grip handle 102 may comprise hand-compressible materials well known in the art as suitable for a comfortable gripping surface for a human hand, including naturally derived and synthetic materials like rubbers, foams, plastics, and like materials.

As further shown in FIG. 1, the housing 104 includes the applicator head 105, which is further adapted to rotate, oscillate, and/or vibrate under the driving force of the electrically-powered motor. The power source may include at least one replaceable or rechargeable battery, or electrical power direct from an electrical outlet, or combinations thereof. The motor may comprise a small, compact, electrically powered motor of the type well known in the art for powering hand-held devices. The connection between the applicator head 105 and motor is adapted to transfer the power of the motor to the applicator head 105 so the head may rotate, oscillate, and/or vibrate under the control of the user. Said connection may include electromagnetic, electromechanical, piezoelectric, or mechanical means.

The applicator head 105 is further adapted to accommodate a plurality of skin-compatible applicator head covers 105a. By way of non-limiting example only, the plurality of skin-compatible applicator head covers may include, a loofah cover, a sponge cover, a chamois cover or other cover derived from animal skin, a cloth cover or other cover derived from plant or synthetic material, like cotton, nylon, or polyester, non-porous or plastic covers, a textured or brush-like cover, or other covers suitable for contact with skin, including human skin. In some embodiments, it may be preferable that the skin-compatible applicator head cover is adapted to be generally non-absorbent so that any fluid, ointment, cream, lotion, suntan oil, soap, etc. applied to the head cover is substantially transferred to the area of interest and not absorbed by the head cover. A desirable feature of such a non-absorbent head cover is that it can be easily cleaned and is reusable.

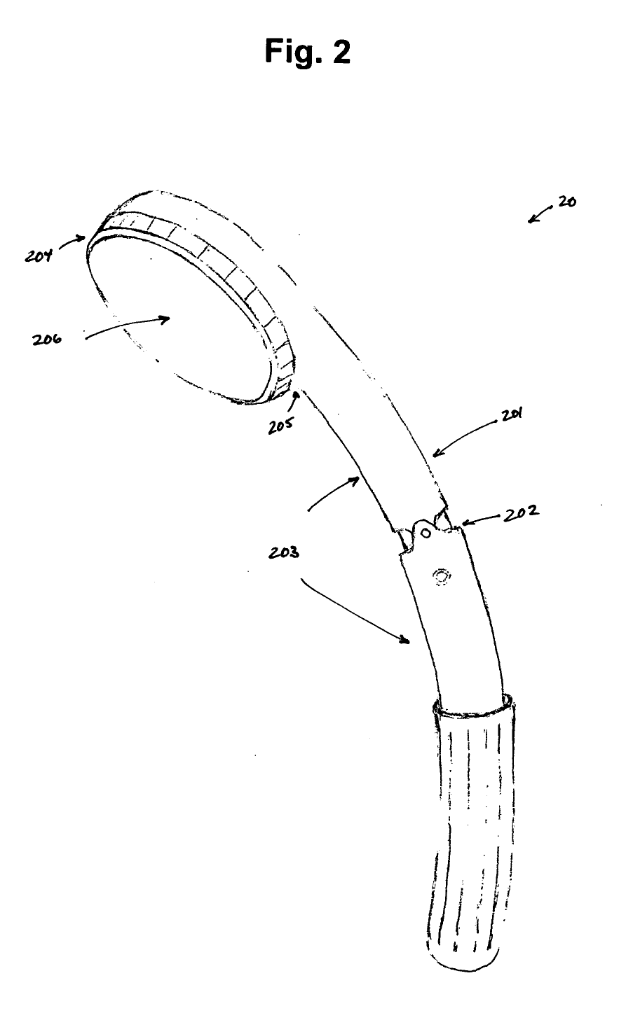

In another embodiment of the cosmetic device shown in FIG. 2, the variable length shaft 201 includes at least one hinge 201a to fold and unfold the shaft 201 along its length. In a preferred embodiment of the cosmetic device, the variable length shaft 201 is arched 203 to allow the user to effectively position the device to reach hard-to-reach areas without having to uncomfortably contort the arm and shoulder. The arched shaft 203, in relation to the applicator base 204, creates an acute angle 205 that further allows the user to apply a substantial area of the applicator base surface 206 to the area of interest—again without having to uncomfortably contort the arm and shoulder to reach the area. The device is further adapted to be lightweight and portable. Preferably, the device would weigh less than five pounds, more preferably, 1 to 3 pounds.

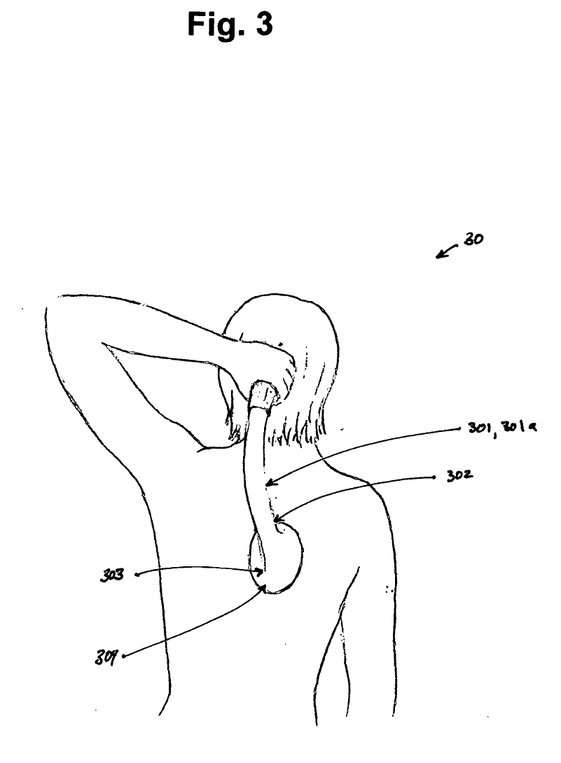

FIG. 3 shows an embodiment illustrating how the arched, elongated shaft 301a and the acute angle 302 formed between the terminal end of the shaft 303 and the applicator head 304 allows a user 30 of the cosmetic device 301 to apply a substantial area of the applicator base surface 105, 206 to a hard-to-reach area of a human back without having to uncomfortably contort the arm and shoulder to reach the area.

It is to be understood that the above description is intended to be illustrative and not restrictive. For example, the above-described embodiments and variations may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A hand-held cosmetic device comprising:
a. a variable length shaft;
b. an electrically-powered motor;
c. a housing including an applicator head;
d. at least one skin-compatible applicator head cover; and
e. a weight of less than 5 pounds.

2. The cosmetic device of claim 1 further comprising:
a. a variable length shaft, including a telescopic shaft;
b. an applicator head adapted for mechanical movement; and
c. a plurality of skin-compatible applicator head covers.

3. The cosmetic device of claim 2 further comprising:
a. a variable length shaft, including a folding shaft.

4. The cosmetic device of claim 2 further comprising:
a. an electrically-powered motor powered by at least one battery and adapted for user-selectable movement including rotation, oscillation, vibration, or combinations thereof;
b. a plurality of skin-compatible applicator head covers; and
c. a weight of about 1 pound to about 3 pounds.

5. The cosmetic device of claim 4 further comprising:
a. a plurality of reusable, generally non-absorbent skin-compatible applicator head covers comprising synthetic materials.

6. The cosmetic device of claim 4 further comprising:
a. a plurality of reusable, generally non-absorbent skin-compatible applicator head covers comprising natural materials.

7. The cosmetic device of claim 4 further comprising:
a. a plurality of reusable, generally non-absorbent skin-compatible applicator head covers comprising synthetic and natural materials.

8. The cosmetic device of claim 4 further comprising:
a. an electrically powered motor powered by at least one rechargeable battery.

9. The cosmetic device of claim 4 further comprising:
a. an electrically powered motor powered by direct electrical connection.

10. The cosmetic device of claim 4 further comprising:
a. an applicator head adapted for user-programmable movement.
